(19) United States
(12) Patent Application Publication
(10) Pub. No.: US 2016/0246786 A1
(43) Pub. Date: Aug. 25, 2016

(54) SYSTEMS AND METHODS FOR NETWORK TRANSMISSION OF MEDICAL IMAGES

(71) Applicant: International Business Machines Corporation, Armonk, NY (US)

(72) Inventors: Igor Kostirev, Kibutz Adamit (IL); Alex Melament, Kiriat Mozkin (IL); Ariel Farkash, Shimshit (IL); Yardena L. Peres, Haifa (IL); Edward Vitkin, Nesher (IL)

(21) Appl. No.: 14/625,634

(22) Filed: Feb. 19, 2015

(51) Int. Cl. G06F 17/30; G06K 9/62; G06T 7/00

(52) U.S. Cl. CPC G06F 17/3028; G06T 7/0012; G06K 9/6256; G06F 17/30268

(57) ABSTRACT

There is provided a method for receiving an image series including at least one image object, comprising: receiving, at an imaging server, a network message from an imaging client, the network message indicative of a start of transmission of an image series; applying a trained classifier to the network message to determine a number of image objects associated with the image series; counting the number of image objects transmitted by the imaging client and received at the imaging server; and generating a message indicative of termination of the image series when the determined number of image objects have been received at the imaging server.

### FIELD AND BACKGROUND OF THE INVENTION

The present invention, in some embodiments thereof, relates to systems and methods for transmission of images and, more specifically, but not exclusively, to systems and methods for network transmission of an image series containing multiple image objects.

Medical images are generated by different imaging modalities, for example, CT, MRI, X-ray, fluoroscopy, endoscopy, and colonoscopy. To provide a framework that allows for storing, displaying, and transmitting of different medical images, different solutions have been proposed. One solution is the Digital Image and Communication in Medicine (DICOM) standard.

A picture archiving and communication system (PACS) centrally stores DICOM images received from different modalities. The storage is performed using a defined C-STORE operation, which controls movement of the DICOM images (and/or other data types) between the Application Entities (AE). C-STORE sends DICOM data objects as a DICOM image series, from the source AE to the target AE over a DICOM network.

### SUMMARY OF THE INVENTION

According to an aspect of some embodiments of the present invention there is provided a method for receiving an image series including at least one image object, comprising: receiving, at an imaging server, a network message from an imaging client, the network message indicative of a start of transmission of an image series; applying a trained classifier to the network message to determine a number of image objects associated with the image series; counting the number of image objects transmitted by the imaging client and received at the imaging server; and generating a message indicative of termination of the image series when the determined number of image objects have been received at the imaging server.

Optionally, the network message includes a C-STORE operation request defined by the Digital Imaging and Communication in Medicine (DICOM) standard to store the image series at an image repository in communication with the imaging server, the image series is a DICOM series, the image objects are DICOM data objects, and the generated message terminates the C-STORE operation session.

Optionally, the method further comprises extracting at least one metadata field from the network message, and wherein applying the trained classifier comprises applying the trained classifier to the extracted at least one metadata field. Optionally, the at least one metadata field is a DICOM tag.

Optionally, the method further comprises triggering an update of the trained classifier when the number of image objects are not determined by the applied trained classifier, the update performed according to the received network message and counted number of image objects.

Optionally, the method further comprises when the number of image objects are not determined by the applied trained classifier, waiting a predefined period of time by the imaging server after the last image object is received to ensure that a complete set of image objects have been transmitted by the imaging client and received by the imaging server and to account for network transmission problems. Optionally, the period of time is about 4-10 minutes.

Optionally, the method further comprises selecting a certain trained classifier from a plurality of trained classifiers according to at least one metadata field of the network message, wherein the at least one metadata field is indicative of a member selected from the group consisting of: medical institution name, acquisition imaging modality, and imaging protocol; and wherein applying the trained classifier comprises applying the selected certain trained classifier to at least one of the other metadata fields of the network message.

Optionally, the network message includes at least one of: a first image object of the image series, a request to store the image series, and a notification command that the transmission of the image series is starting.

According to an aspect of some embodiments of the present invention there is provided a method for training a classifier to predict a number of image objects associated with an image series from a network message, comprising: receiving at least one network message originating from an imaging client, each network message includes at least one of: a request for storing an image series at a storage in communication with an imaging server, and a first image object of the image series; receiving a number of image objects for each corresponding image series; training a classifier, using the received at least one network message and the received number of image objects, to predict the number of image objects according to features extracted from metadata of the received network message.

Optionally, the trained classifier is a set of rules based on a decision tree.

Optionally, the method further comprises designating a data source of the network message according to the metadata of the network message, and wherein training the classifier comprises training a plurality of classifiers, each classifier trained according to a respective data source. Optionally, training the classifier comprises updating the certain classifier corresponding to the respective data source using the metadata of the network message and the corresponding number of image objects.

Optionally, the method further comprises collecting a plurality of network messages, and performing the training when a predefined number of network messages having the same metadata source are classified to the same number of image objects.

Optionally, training a classifier comprises generating a decision tree by recursively splitting the features according to a certain feature having lowest calculated entropy, and converting the decision tree to a set of rules from zero entropy leaves.

According to an aspect of some embodiments of the present invention there is provided a system for transferring an image series including at least one image object between an image client and an image server, comprising: an image server in communication with an image repository, comprising: a data interface configured to receive a network message from an imaging client over a network, the network message indicative of a start of transmission of an image series for storing at the image repository; a trained classifier configured to predict a number of image objects associated with the image series according metadata extracted from the network message; and a storage controller configured to count the number of received image objects and to generate a message indicative of termination of the image series when the determined number of image objects have been received.

Optionally, the image server is a remotely located client, and the imaging client is a picture archiving and communication system (PACS) server, the image server and imaging client being operated by different entities.

Optionally, the image server is an external long-term Vendor Neutral Archive (VNA) server, and the imaging client is a PACS server.

Optionally, the system further comprises a learning module configured to at least one of generate the trained classifier and update the trained classifier, the training triggered when the trained classifier generates a message indicative of a lack of classification of the network message, the training performed using metadata of the received network message and the number of image objects.

Optionally, the image repository is part of an existing PACS, and the image server is designed to integrate with the existing PACS without modification of the existing PACS.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for transmission of an image series, in accordance with some embodiments of the present invention;

FIG. 2 is a block diagram of components of a system for transmission of an image series, in accordance with some embodiments of the present invention;

FIG. 3 is a schematic of an example of a decision tree for predicting the number of image objects in an image series, in accordance with some embodiments of the present invention;

FIG. 4A is a schematic diagram of an example architecture and related dataflow for receiving an image series, in accordance with some embodiments of the present invention; and

FIG. 4B is a schematic diagram of an example architecture and related dataflow for generating and/or updating a classifier that predicts the number of image objects in an image series, in accordance with some embodiments of the present invention.

### DESCRIPTION OF SPECIFIC EMBODIMENTS OF THE INVENTION

The present invention, in some embodiments thereof, relates to systems and methods for transmission of images and, more specifically, but not exclusively, to systems and methods for network transmission of an image series containing multiple image objects.

An aspect of some embodiments of the present invention relates to systems and methods that allow a receiver (e.g., server) to self detect the end of a network transmission of multiple image objects transmitted as an image series from a sender (e.g., client). The receiver applies a classifier to metadata extracted from the first network message in the series to predict the number of image objects expected in the series. The receiver counts the number of received image objects, and terminates the image series when the counted number reaches the expected determined number of image objects for the series. The identification of termination of the image series is self-performed by the receiver, without additional messages transmitted by the sender, such as without the sender explicitly providing instructions to terminate the series (i.e., when the last image objects has been transmitted), and/or without the sender explicitly providing the number of objects in the series. In this manner, additional control elements do not need to be installed within the system, such as when the receiver and sender are part of different network. The identification of termination of the image series is performed after the receiver receives the last expected image object. The receiver may immediately terminate the image series, without waiting an additional period of time for confirmation of the end of the series, or to make sure that additional image objects are not being transmitted.

Optionally, the image series contains medical images represented as image objects. The image series may include multiple image objects obtained during a study, for example, multiple computed tomography (CT) images obtained during a single CT scan.

Optionally, the network message and/or image series are defined by the Digital Imaging and Communication in Medicine (DICOM) standard. Optionally, the network message includes a C-STORE operation defined by DICOM. The classifier is applied to metadata extracted from one or more DICOM defined fields and/or tags in the C-STORE request, and/or in the first DICOM image object.

Optionally, the network message is designated according to the source, such as the acquisition source, image ordering source, sending source, facility and/or organization, for example, the medical institution name and/or imaging modality. Optionally, the classifier is applied to metadata indicative of the imaging protocol, optionally after the designating.

The classifier may be selected from a set of classifiers, each classifier trained to act on pre-designated metadata. Prediction of the number of image objects may be based on the Inventor's discovery that the same equipment at the same medical institutions acquires images using a limited number of imaging protocols that generate the same number of images. When the source and/or imaging protocol is known, the number of images may be predicted.

Optionally, the classifier is automatically updated, to learn changes in the numbers of image objects for existing metadata classifications (e.g., image procedures). Alternatively or additionally, the classifier is automatically generated and/or automatically updated, to learn new classifications, for example, new imaging protocols, new imaging modalities, and/or new imaging facilities.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

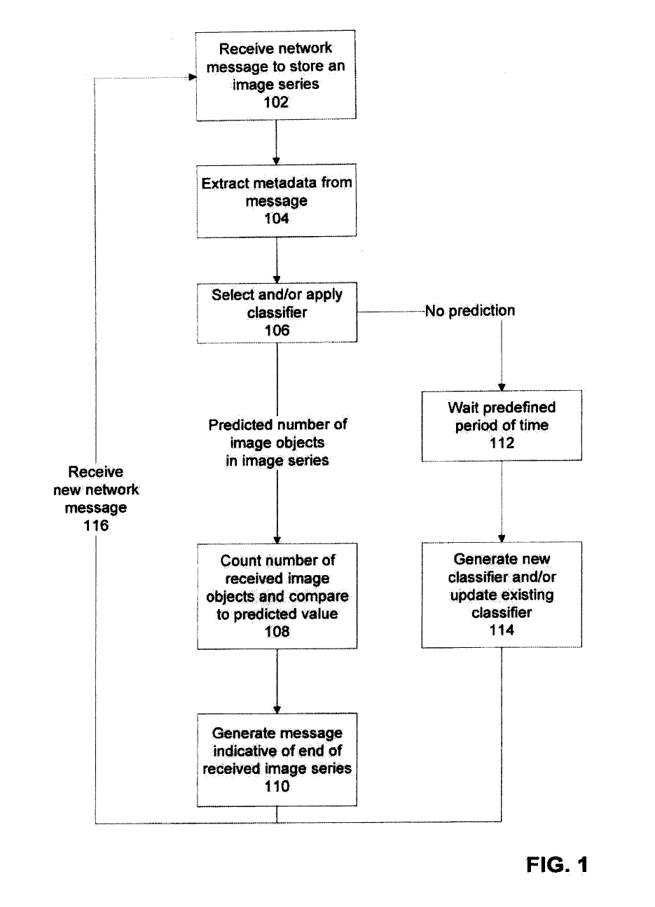

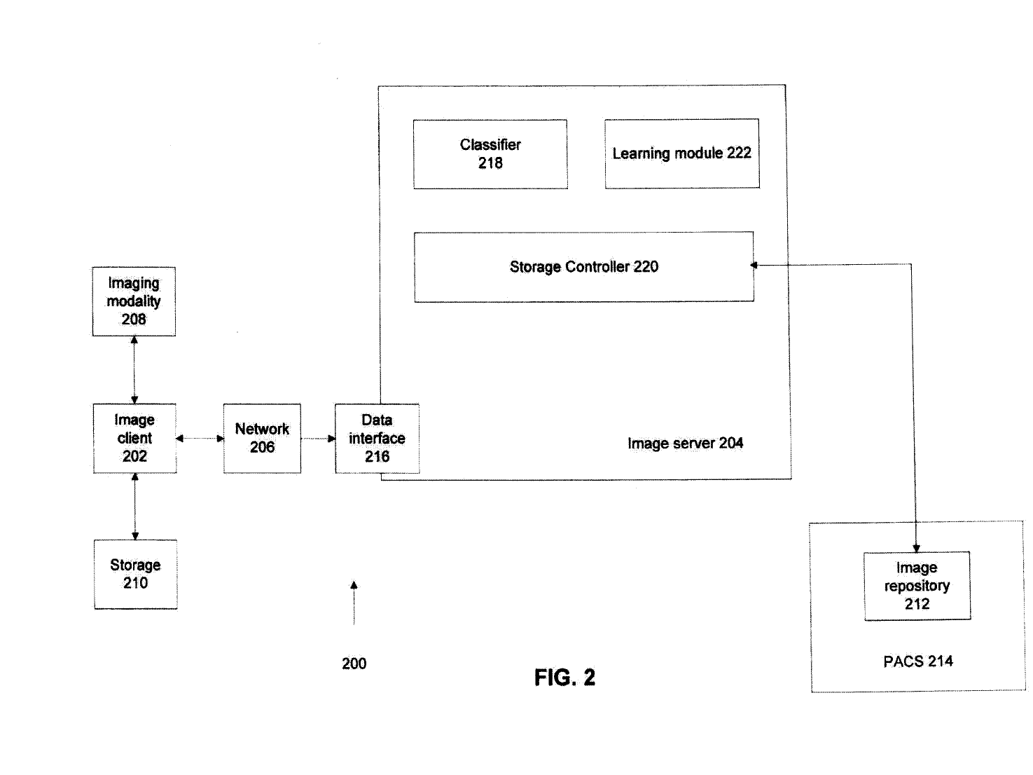

Reference is now made to FIG. 1, which is a flowchart of a method for transmission of images, in accordance with some embodiments of the present invention. Reference is also made to FIG. 2, which is a block diagram of components of a system for transmission of images, in accordance with some embodiments of the present invention. The method allows a sender to transmit an image series to a receiver, without requiring additional control elements and/or control messages to define the end of the image series. The receiver predicts the number of transmitted image objects in the image series, optionally from the first network message, and terminates reception of the transmission once the predicted number of image objects has been received.

System 200 includes an image client 202, transmitting an image series including one or more image objects, to an image server 204 over a network 206. The image series may be obtained from an imaging modality 208, for example, a CT scanner, an MRI machine, an X-ray machine, a fluoroscopy machine, a nuclear medicine machine, an endoscope, and a colonoscope. Alternatively or additionally, the image series is obtained from storage 210 in communication with image client 202, for example, local memory in communication with imaging modality 208, and/or a hard disk in communication with a radiology computer workstation. The image series is transmitted to image server 204, optionally for storage in a connected image repository 212, which may be part of or in communication with a picture archiving and communication system (PACS) server 214.

The systems and/or methods described herein improve efficiency of transmission between image client 202 and image server 204, such as when client 202 and server 204 are part of different local networks, are otherwise unaffiliated entities, are operated by different entities, and/or are affiliated entities that communicate over unsecured networks (e.g., a doctor working from home accessing a server in the hospital). For example, client 202 and server 204 are part of different medical facilities, for example, client 202 is located outside of the hospital in a private clinic, and server 204 is located within the radiology department of the hospital.

Optionally, system 200 allows efficient transfer of the image series in an opposite direction, from central storage (e.g., image repository 212) to a remotely located client (e.g., image client 202). The image series may be transmitted from storage in a hospital, to a private medical practitioner's office computer, for example, when requesting an expert consultation. In such a case, the image client 202 (instead of, or having functionality of image server 204) applies the classifier to the image series to determine the number of image objects, and terminates the image series when the predicted number of image objects have been received, as described herein.

Optionally, system 200 allows efficient transfer of the image series from one storage facility to another storage facility. System 200 allows efficient transfer of a large number of image series and/or a large number of image objects. For example, image server 204 may be an external long-term data storage server, such as a Vendor Neutral Archive (VNA) server receiving the image series from a PACS server (e.g., image client 202). The systems and/or methods described herein retain the storage of image objects in the original standard form (e.g., DICOM), allowing access in a vendor neutral and/or standard manner by interested entities (once access permission is granted).

The systems and/or methods described herein provide an efficient way for the receiver to detect the end of the image series. It is noted that the C-STORE operation used to send the DICOM image series from source Application Entity (AE) to target AE doesn't define when the series is started and stopped. Such start and stop control, defined by the IHE according to IHE RAD technical framework, requires a Performed Procedure Step Manager (PPSM) unit to receive start and stop messages from the sender, and coordinate the image series reception with an Image Manager unit and an Image Archive unit. The systems and/or methods described allow the receiver to automatically detect the end of the image series without requiring the PPSM unit, and optionally without the Image Manager and/or the Image Archive units.

Optionally, image repository 212 is part of an existing PACS 214. Image server 204 is designed to integrate with existing PACS 214 without modification of PACS 214. It is noted that modification of PACS 214 may be expensive, and risk problems in hospital system operations if performed incorrectly. Moreover, additional expensive equipment may not be required to generate work-arounds for the integration, for example, a PPSM, an Image Archive element, and/or an Image Manager element may not be required. Modification of PACS and/or additional equipment for integration according to standards, such as IHE XDS-I.b (to allow delivery of DICOM image series from PACS to a remote client), and/or Multiple Image Manager Archive (MIMA) IHE Radiology Supplement (to allow transfer of DICOM image series from PACS to VNA) may not be required.

The systems and/or methods described herein detect completion of transfer of the image series upon receipt of the last predicted image object. The receiver does not need to wait for an extended period of time (e.g., about 2-3 minutes) to account for delay factors related to transmission over non-reliable communication systems.

The systems and/or methods described herein improve transfer rates of the image series over the network, allowing mass transfer of image data, such as at the regional and/or national level, such as between large storage facilities. The efficiency is at least in part obtained by the automatic detection of the termination of the image transfer as described herein (e.g., instead of waiting for a period of time after the reception of the last object for confirmation), and/or by not requiring additional control messages, as described herein.

The systems and/or methods reduce the risk of incorrectly partitioning the image series, such as by prematurely terminating the image series before all image objects have been received, by performing the a priori prediction of the expected number of image objects described herein.

At 102, a network message transmitted from imaging client 202 over network 206 is received by image server 204. Optionally, the message is received at a data interface 216 of server 204. The network message may include a request for storing an image series at image repository 212 in communication with imaging server 204. The network message may include the first image object of the series, and/or a request for transmission of the image series, and/or a notification command that the transmission of the image series is starting.

Optionally, the network message includes a C-STORE operation request defined by DICOM. The image series may be a DICOM series. The image objects may be DICOM data objects, for example, medical images, medical reports, and/or medical waveforms (e.g., ECG).

At 104, one or more metadata values are extracted from one or more fields of the network message, optionally by image server 204. Metadata values may be extracted from DICOM tags.

Optionally, the metadata field is indicative of one or more of: medical institution name, acquisition imaging modality, and imaging protocol. Examples of extracted DICOM tags that describe the study protocol and/or acquisition modality that generated the received DICOM series include: General Study, General Equipment, and Image Pixels. Inventors discovered that each acquisition modality in each department and/or each imaging facility (e.g., hospital) uses a limited number of imaging scenarios. For example, an imaging protocol for a CT of a knee in a hospital defines the number of images that are to be scanned. The number of expected image objects in the image series may be determined based on the extracted medical institution, acquisition modality, and/or imaging protocol, either exclusively, and/or along with additional values from other Metadata fields.

Alternatively or additionally, metadata values are extracted from one or more additional fields, for example, patient birthday, patient gender, ordering physician, and image pixel data.

The metadata may be extracted from mandatory fields, and optionally from optional fields, for example, DICOM procedure code Performed Protocol Code Sequence (0040, 0260). Optional fields may not need to be relied upon for the classification, as they may be omitted by the source image client.

At 106, a trained classifier 218 is applied to the metadata extracted from the network message. Optionally, classifier 218 outputs a predicted a number of image objects associated with the incoming image series. Alternatively, classifier 218 outputs a message indicative that the extracted metadata is not classifiable to a predicted number of image objects. Alternatively, no classifier 218 is available, for example, classifier 218 has not been generated to classify the extracted metadata values.

Optionally, the network message is first designated according to the extracted source metadata, for example, according to one or more of: the name of the source medical institution (e.g., hospital, referring physician, and department), the imaging modality that acquired the images, and/or the imaging protocol. A certain trained classifier is designated from a set of multiple trained classifiers according to the source metadata. The certain trained classifier is applied to one or more other metadata fields, and optionally to one or more of the source metadata fields. Different classifiers may perform the classification using different metadata fields. The extraction may be generally performed in advance, or performed after selection of the classifier according to the metadata inputs for the selected classifier. The designation and selection of the classifier may improve accuracy and/or efficiency in prediction of the number of image objects, based on the inventor's observation that each source generates a limited number of image types, as discussed herein.

Alternatively, all (or a selected subset) of the extracted metadata parameters are used by a general classifier to predict the number of image objects in the image series.

At 108, the number of image objects transmitted by image client 202 and received at image server 204 is counted, optionally by a storage controller 220. The number of received image objects is compared to the predicted number of image objects.

At 110, when the predicted number of image objects have been received by image server 204 (and optionally stored in image repository 212), a message indicative of termination of the image series is generated, optionally by storage controller 220. The generated message may trigger finalization of the image series, for example, making the received and/or stored image series available for use (e.g., viewing, printing, image processing, and transmission to another location).

The generated message may trigger termination of the C-STORE operation session. The generated message may trigger termination of a communication session established over the network for transmission of the image series. The generated message may trigger availability of the resources reserved for reception and/or storage of the image series, for example, processing resources, memory resources, and/or network bandwidth.

Optionally, at 112, the classifier is unable to classify the extracted metadata to a predicted number of image objects. The classifier may generate a message indicative that no classification has been performed, for example, an impossible number of image objects, such as a negative number, for example, −1.

Optionally, when the number of image objects is not determined by the applied trained classifier, the trained classifier is updated with the new metadata information. Alternatively, a new classifier is generated.

Image server 204 waits a predefined period of time after the last image object is received, to ensure that a complete set of image objects have been transmitted by image client 202 and received by image server 204, while optionally accounting for transmission delays and/or errors, for example, re-transmission required due to transmission errors over unreliable networks and/or noisy media.

Optionally, the period of time is about 4-10 minutes, or about 6-15 minutes, or about 2-3 minutes, or about 4-5 minutes, or about 5-6 minutes, or about 6-7 minutes, or about 7-8 minutes, or about 8-9 minutes, or other periods of time. The period of time may be long enough to provide a confidence of at least about 90% that all transmitted image objects have been received, or at least about 95%, or 99%, or 99.9%, or other probability percentages. The period of time may be at least about 2 times, or 3 times the default system timeout value for waiting for data transmission over the network. The time interval is selected to be very long, to ensure that all image objects have been received, as such long waiting time periods are not expected to occur often, occurring during initial generation of the classifier and/or updating of the classifier. Alternatively, the system default timeout periods may be used.

Data to generate and/or update the classifier is collected from the received image series. The number of received image objects is counted by storage manager 220, as described herein. Metadata values may be extracted as described herein. Alternatively or additionally, the set of metadata values for extraction is determined as part of the classifier training process.

At 114, the classifier is updated according to the metadata extracted from the received network message and the counted number of image object. Alternatively, when a classifier does not exist, a new classifier is trained. The classifier is trained using the metadata extracted from the received network message and the counted received number of image objects, optionally by a learning module 222.

The classifier may be trained using supervised learning and/or unsupervised learning approaches. Supervised learning may be used, as the data is already grouped. The classifier is trained to map the extracted metadata values (or subset thereof) to the number of image objects in the image series.

Optionally, the trained classifier is a set of rules based on a decision tree. Optionally, the classifier is trained according to the C4.5 algorithm developed by Ross Quinlan, described with reference to “Quinlan, J. R. C4.5: Programs for Machine Learning. Morgan Kaufmann Publishers, 1993”, incorporated herein in its entirety. The C4.5 may be used without necessarily defining a statistical distance metric and/or inter-sample distance function. Defining such statistical distance may be difficult and/or unclear using the metadata fields, such as the DICOM tags.

Optionally, a data source of the network message is designated according to the extracted source metadata of the network message. The classifier may be trained according to data collected from respective data sources. Optionally, multiple classifiers are trained, with each classifier trained according to the source designation.

Optionally, data is collected in an amount sufficient to train the classifier. The classifier is trained when a predefined number of the network messages having the same metadata source and/or originating from the same source are classified to the same number of image objects. For example, when 25 CT scans from a certain hospital have been collected. The predefined number may be selected according to a desired statistical certainty, for example, to achieve a statistical classification certainty of at least 90%, or at least 99%. Training may be performed using the full dataset of the predefined number of image series, when the full dataset becomes available.

Optionally, image series having a number of image objects below a predefined threshold are filtered out. The predefined threshold may be selected to remove errors in transmission of the images, and/or cases of extreme outliers. Filtering may be performed according to source. For example, CT scan series having less than 20 individual images are removed, as such scans are unusual, and/or represent an error case in missing remaining images.

Optionally, the classifier is trained by generating a decision tree, by recursively splitting the extracted metadata parameters according to the parameters having the lowest entropy values. The zero entropy leaves of the decision tree are converted to a set of rules. The classifier includes the set of rules.

An exemplary method to generate the set of rules is now described:

The dataset of image series are positioned in the same root node. The entropy for the node is calculated according to the equation:

$$H ( \{ samples \} ) = - {\sum }_{{label}_{i}} [ ( \frac{\vert \{ samples with {label}_{i} \} \vert}{\vert \{ samples \} \vert} ) * log ( \frac{\vert \{ samples with {label}_{i} \} \vert}{\vert \{ samples \} \vert} ) ]$$

For each extracted metadata feature (designated as a), the information gain (IG) of a split according to the value of the extracted metadata feature is defined according to the relationship:

$$IG ( split by tag = {}_{}^{``}{a}{}_{}^{″} ) = H ( \{ samples \} ) - {\sum }_{v ∈ \{ {values}_{a} \}} [ \frac{\vert \{ x ∈ samples \text{:} {x}_{a} = v \} \vert}{\{ samples \}} * H ( \{ {sample}_{a} = v \} ) ]$$

The extracted metadata feature having the highest Information Gain value is selected for the split. When the metadata tag contains continuous values, an optimal cut-off value is selected for the binary split, dividing the data into values below the cut-off value and above the cut-off value. Alternatively, one or more of the metadata tags acting as splitting features may be pre-defined, for example, manually.

The described example method is performed recursively to select the metadata tag for performing each split. At each stage, the previously selected tags are removed from consideration. The recursion continues until a leaf node is reached, having zero entropy value (when all of the image series in the node have the same label), and/or exceeding a predefined lower limit for the number of samples in each leaf.

The decision tree is converted to the set of rules from the zero-entropy leaves. The rules act as the classifier, as described herein.

Optionally, at 116, a new network message is received. Once the series has been finalized, the new network message is assumed to represent the start of a new series.

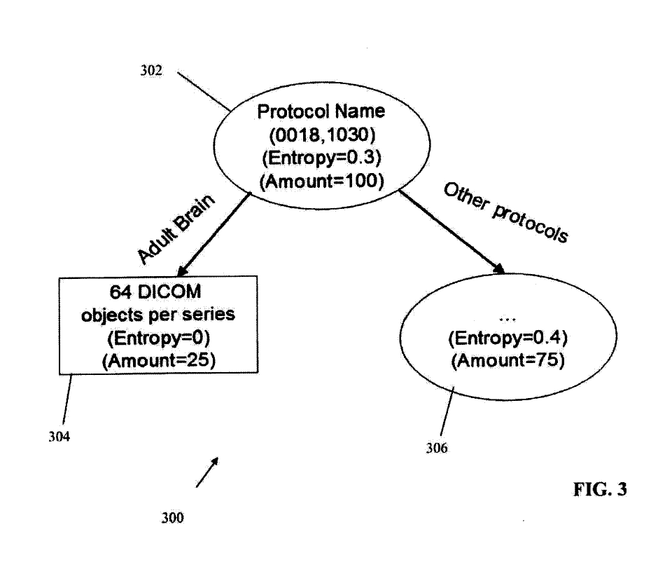

Reference is now made to FIG. 3, which is a schematic diagram of an example of a decision tree 300, in accordance with some embodiments of the present invention. An example of generating the set of rules from decision tree 300 is described. Image server 204 has received 100 DICOM image series from the same acquisition imaging modality 208, which is a CT machine. Root node 302 represents the full set of the image series. The calculated entropy is 0.3. The metadata DICOM tag Protocol Name (0018,1030) is selected for splitting the set of image series, into node 304 (which is also a leaf node), and another node 306 which is further split. Node 304 contains 25 of the image series that have the same value of CT brain for the metadata DICOM tag Protocol Name (0018,1030). It is noted that in this example, 25 is the lower limit for the leaf size (i.e., the number of samples needed to generate a decision rule from the leaf). Since the 25 members of the DICOM series are generated using the same protocol from the same imaging modality (from the same hospital), the number of image objects in each series is the same (i.e., 64 in this example).

Image series members designated to leaf node 304 have an entropy of 0. Leave node 304 is used to generate a rule for classification:

RULE 1:

IF:
Hospital_ID==X AND AM_ID==Y
   AND Protocol_Name==“ADULT BRAIN”

THEN:
Wait for total of 64 objects in this DICOM series.

The source metadata tags are the Hospital_ID (originating hospital, e.g., image client 202) and AMID (acquiring imaging modality, e.g., imaging modality 208). (It is noted that all 100 members of node 302 have the same (or similar) values for Hospital_ID and AMID). When the received image series also has the value of ADULT BRAIN for the Protocol_Name tag, the receiver (e.g. image server 204) waits to receive 64 image objects before terminating the reception of the series.

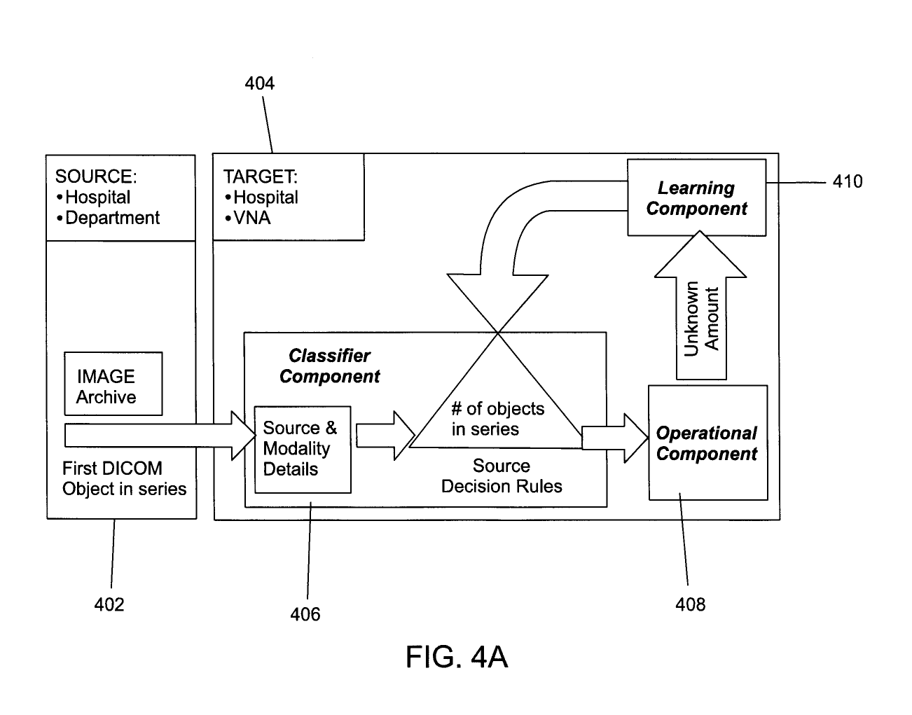

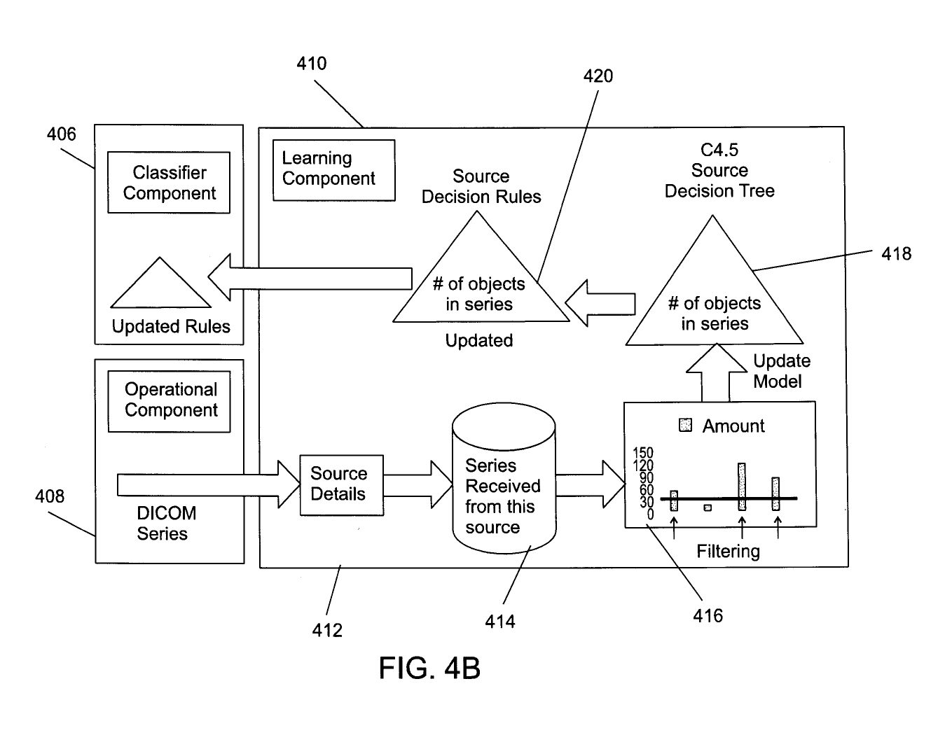

Reference is now made to FIG. 4A, which is a schematic diagram of an example architecture and related dataflow for receiving an image series, based on the method of FIG. 1 and/or the system of FIG. 2, in accordance with some embodiments of the present invention. A first DICOM image object 402 in an image series is transmitted to a target 404 such as a hospital server and/or a VNA server. Object 402 contains metadata tags having values indicative of the originating source, such as the hospital and/or department.

Object 402 is processed by a classifier component 406. The source and/or imaging modality values are extracted from respective metadata tags of image object 402. A set of decisions rules is selected according to the source and/or imaging modality values. The set of rules predict the total number of objects to be received in the transmitted image series.

Operational component 408 counts the number of received objects in the image series, and terminates and/or finalizes the reception when the predicted number of objects has been received.

When the set of rules cannot predict the number of image objects, or a set of rules does not exist for the corresponding source and/or modality tag values, learning component 410 generates and/or updates the set of rules. Learning component 410 receives the counted number of image objects in the image series, as counted by operational component 408. Learning component 410 generates and/or updates the set of rules as described below with reference to FIG. 4B. The generated and/or updated set of rules is provided to classifier 406 for future classification.

Reference is now made to FIG. 4B, which is a schematic diagram of an example architecture and related dataflow for generating and/or updating a classifier that predicts the number of image objects in an image series, based on the methods of FIG. 1 and/or the system of FIG. 2, in accordance with some embodiments of the present invention.

Learning component 410 is triggered by operational component 408 to update the set of rules or generate a new set of rules. Learning component is provided with the counted number of image objects in the received DICOM series.

Learning component 410 receives and/or extracts metadata values related to the source of the received DICOM image series, for example, the source hospital and/or the imaging modality. The received DICOM series is classified according to the source, and stored in repository 414 along with other image series received from the same source (i.e., having the same or similar values for the metadata source tags).

A filter 416 selects the series group(s) stored in repository 414 that contain a number of members (i.e., image series) above a predefined threshold, for example, 30.

The number of image objects in each image series of the selected group (which is expected to be the same number), is used as input by a C4.5 algorithm module 418 to generate a decision tree and/or update the existing decision tree.

A source decision rules module 420 generates a new set of rules, and/or updates the existing set of rules from the generated decision tree.

The new set of rules and/or the updated set of rules are provided to classifier 406 for performing classification of received DICOM series.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term classifier, image series, and image object are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for receiving an image series including at least one image object, comprising:
receiving, at an imaging server, a network message from an imaging client, the network message indicative of a start of transmission of an image series;
applying a trained classifier to the network message to determine a number of image objects associated with the image series;
counting the number of image objects transmitted by the imaging client and received at the imaging server; and
generating a message indicative of termination of the image series when the determined number of image objects have been received at the imaging server.

2. The method of claim 1, wherein the network message includes a C-STORE operation request defined by the Digital Imaging and Communication in Medicine (DICOM) standard to store the image series at an image repository in communication with the imaging server, the image series is a DICOM series, the image objects are DICOM data objects, and the generated message terminates the C-STORE operation session.

3. The method of claim 1, further comprising: extracting at least one metadata field from the network message, and wherein applying the trained classifier comprises applying the trained classifier to the extracted at least one metadata field.

4. The method of claim 3, wherein the at least one metadata field is a DICOM tag.

5. The method of claim 1, further comprising: triggering an update of the trained classifier when the number of image objects are not determined by the applied trained classifier, the update performed according to the received network message and counted number of image objects.

6. The method of claim 1, further comprising: when the number of image objects are not determined by the applied trained classifier, waiting a predefined period of time by the imaging server after the last image object is received to ensure that a complete set of image objects have been transmitted by the imaging client and received by the imaging server and to account for network transmission problems.

7. The method of claim 6, wherein the period of time is about 4-10 minutes.

8. The method of claim 1, further comprising:
selecting a certain trained classifier from a plurality of trained classifiers according to at least one metadata field of the network message, wherein the at least one metadata field is indicative of a member selected from the group consisting of: medical institution name, acquisition imaging modality, and imaging protocol; and
wherein applying the trained classifier comprises applying the selected certain trained classifier to at least one of the other metadata fields of the network message.

9. The method of claim 1, wherein the network message includes at least one of: a first image object of the image series, a request to store the image series, and a notification command that the transmission of the image series is starting.

10. A method for training a classifier to predict a number of image objects associated with an image series from a network message, comprising:
receiving at least one network message originating from an imaging client, each network message includes at least one of: a request for storing an image series at a storage in communication with an imaging server, and a first image object of the image series;
receiving a number of image objects for each corresponding image series;
training a classifier, using the received at least one network message and the received number of image objects, to predict the number of image objects according to features extracted from metadata of the received network message.

11. The method of claim 10, wherein the trained classifier is a set of rules based on a decision tree.

12. The method of claim 10, further comprising:
designating a data source of the network message according to the metadata of the network message, and
wherein training the classifier comprises training a plurality of classifiers, each classifier trained according to a respective data source.

13. The method of claim 12, wherein training the classifier comprises updating the certain classifier corresponding to the respective data source using the metadata of the network message and the corresponding number of image objects.

14. The method of claim 10, further comprising:
collecting a plurality of network messages, and performing the training when a predefined number of network messages having the same metadata source are classified to the same number of image objects.

15. The method of claim 10, wherein training a classifier comprises generating a decision tree by recursively splitting the features according to a certain feature having lowest calculated entropy, and converting the decision tree to a set of rules from zero entropy leaves.

16. A system for transferring an image series including at least one image object between an image client and an image server, comprising:
an image server in communication with an image repository, comprising:
a data interface configured to receive a network message from an imaging client over a network, the network message indicative of a start of transmission of an image series for storing at the image repository;
a trained classifier configured to predict a number of image objects associated with the image series according metadata extracted from the network message; and
a storage controller configured to count the number of received image objects and to generate a message indicative of termination of the image series when the determined number of image objects have been received.

17. The system of claim 16, wherein the image server is a remotely located client, and the imaging client is a picture archiving and communication system (PACS) server, the image server and imaging client being operated by different entities.

18. The system of claim 16, wherein the image server is an external long-term Vendor Neutral Archive (VNA) server, and the imaging client is a PACS server.

19. The system of claim 16, further comprising:
a learning module configured to at least one of generate the trained classifier and update the trained classifier, the training triggered when the trained classifier generates a message indicative of a lack of classification of the network message, the training performed using metadata of the received network message and the number of image objects.

20. The system of claim 16, wherein the image repository is part of an existing PACS, and the image server is designed to integrate with the existing PACS without modification of the existing PACS.
